(19) United States
(12) Patent Application Publication
(10) Pub. No.: US 2026/0300640 A1
(43) Pub. Date: Oct. 1, 2026

(54) METHOD AND SYSTEM FOR EXTRACTING AND NORMALIZING TEMPORAL INFORMATION FROM AN INPUT TEXT

(71) Applicant: Panasonic Intellectual Property Management Co., Ltd., Osaka (JP)

(72) Inventors: YUEJINGXIAN MAO, Singapore (SG); ZHEHAN NI, Singapore (SG); YIZHOU HUANG, Singapore (SG); KOJI MIURA, Osaka (JP)

(21) Appl. No.: 19/090,457

(22) Filed: Mar. 26, 2025

(51) Int. Cl. G06F 40/40; G06F 40/103; G06F 40/205; G06F 40/289

(52) U.S. Cl. CPC G06F 40/40; G06F 40/103; G06F 40/205; G06F 40/289

(57) ABSTRACT

The present disclosure relates to a method for extracting and normalizing one or more temporal elements from an input text. The method includes preprocessing an input text based on sentence chunking. The method includes identifying, using a hybrid temporal extraction (TE) module, temporal expressions comprising structured temporal expressions and unstructured temporal expressions, from the pre-processed input text. Further, the method includes deduplicating, using the hybrid TE module, the temporal expressions detected by a rule-based approach and a trained machine learning (ML) model. The method includes normalizing, using a temporal normalization (TN) module, the deduplicated temporal expressions into a standardized format, based on a hybrid normalization framework and a reference date. Furthermore, the method includes generating, using the TN module, an output comprising the one or more temporal elements highlighted among the input text based on the standardized format.

### FIELD OF THE INVENTION

The present disclosure relates generally to Natural Language Processing (NLP), and more specifically, to method and system for extracting and normalizing one or more temporal elements from an input text.

### BACKGROUND

Temporal information processing plays a vital role in many applications within the field of Natural Language Processing (NLP). Temporal data provides critical insights into the timing and sequencing of events, actions, and contexts. Whether in document analysis, event prediction, scheduling, or historical analysis, understanding time-based relationships in unstructured text is crucial for achieving meaningful insights and effective decision-making.

In NLP, temporal extraction refers to the task of identifying and extracting temporal expressions from text, such as dates, times, durations, intervals, and event sequences. These temporal expressions can be explicit, such as “January 1st, 1105,” or implicit, such as “next Friday,” “in two weeks,” or “soon.” Temporal extraction enables NLP systems to comprehend when actions or events occur, how long they last, and how they relate to one another in time.

However, temporal extraction presents several challenges, primarily due to the diverse and context-dependent nature of temporal expressions. Time can be expressed in various forms and formats depending on the context, making it difficult for existing techniques to accurately identify and interpret these references. For instance, expressions such as “last Friday,” “next month,” or “in two days” may vary based on the current date or the reference point in the text. The ambiguity of these expressions, compounded with natural language's inherent flexibility, introduces complexity to the task of extracting time-related information.

Existing approaches to temporal extraction have relied heavily on rule-based systems that use predefined patterns or regular expressions to match temporal phrases in text. The existing approaches can be highly effective when dealing with structured or semi-structured data, where temporal expressions follow well-established patterns. For example, regular expressions can efficiently extract standard date formats like “MM/DD/YYYY” or “YYYY-MM-DD.” However, the existing techniques struggle to handle more nuanced or ambiguous temporal references, especially when these expressions deviate from predictable formats. Furthermore, rule-based methods lack the ability to handle context-dependent temporal information or account for the dynamic nature of natural language.

In response to these limitations, more recent techniques in temporal extraction have incorporated Machine Learning (ML) and Deep Learning (DL) models. These ML and DL models are trained on large datasets to recognize and classify temporal entities, enabling the ML and DL models to detect more complex time expressions beyond what can be captured by rules alone. One potential limitation of the ML and DL models is their difficulty in interpreting abbreviations or domain-specific terms, such as “ETA” or “ASAP,” which may pose challenges for NLP systems. Some existing techniques may use rule-based system to interpret such abbreviations. Further, even ML/DL-based approaches often face significant challenges in temporal normalization. Temporal normalization refers to the task of converting extracted temporal expressions into a standardized, absolute format, such as converting “next Friday” into a specific date (e.g., “Feb. 23, 1105”). The temporal normalization process is critical for downstream applications that require precise and actionable temporal data, yet it is not trivial. For instance, relative time expressions like “next Monday” or “in two weeks” need to be interpreted based on the reference point, which could be the current date, an event date, or another temporal anchor in the text. The temporal normalization also involves handling complex scenarios, such as resolving holidays or time zones, which further complicate the standardization process. A reference like “Christmas” or “Labor Day” needs to be mapped to the specific date for a given year, and the handling of time zones and daylight savings time must be factored into the normalization of temporal data when applicable.

Furthermore, the existing techniques fail to handle temporal reasoning. The temporal reasoning is the ability to understand and process the relationships between temporal entities. These relationships include understanding when one event happens before or after another, recognizing intervals (e.g., “between 9 AM and 5 PM”), and determining durations (e.g., “for two weeks”). Temporal reasoning is particularly important for applications like event planning or historical analysis, where the sequence and timing of events need to be accurately modelled.

Hence, while the existing techniques have made strides in extracting basic time-related information, they fall short when dealing with ambiguous, context-dependent, or complex temporal expressions. The existing techniques also lack the necessary flexibility, reasoning capabilities, and normalization techniques to accurately process and standardize temporal data in a wide range of natural language contexts.

Thus, there is a need for more advanced, flexible, and accurate frameworks for temporal extraction and normalization, which can handle diverse, context-dependent, and complex time-related expressions effectively.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for extracting and normalizing one or more temporal elements from an input text is disclosed. The method includes preprocessing an input text based on sentence chunking. Further, the method includes identifying, using a hybrid temporal extraction (TE) module, temporal expressions comprising structured temporal expressions and unstructured temporal expressions, from the pre-processed input text. Furthermore, the method includes deduplicating, using the hybrid TE module, the temporal expressions detected by the rule-based approach and the trained ML model. Furthermore, the method includes normalizing, using a temporal normalization (TN) module, the deduplicated temporal expressions into a standardized format, based on a hybrid normalization framework and a reference date. Furthermore, the method includes generating, using the TN module, an output comprising the one or more temporal elements highlighted among the input text based on the standardized format.

According to an embodiment of the present disclosure, a system for extracting and normalizing one or more temporal elements from an input text is disclosed. The system includes a memory and at least one processor in communication with the memory. The at least one processor is configured to preprocess an input text based on sentence chunking. Further, the at least one processor is configured to identify, using a hybrid temporal extraction (TE) module, temporal expressions comprising structured temporal expressions and unstructured temporal expressions, from the pre-processed input text. Furthermore, the at least one processor is configured to deduplicate, using the hybrid TE module, the temporal detected by the rule-based approach and the trained ML model. Furthermore, the at least one processor is configured to normalize, using a temporal normalization (TN) module, the deduplicated temporal expressions into a standardized format, based on a hybrid normalization framework and a reference date. Furthermore, at least one processor is configured to generate, using the TN module, an output comprising the one or more temporal elements highlighted among the input text based on the standardized format.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting to its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment including a system for extracting and normalizing one or more temporal elements from an input text, according to an embodiment of the present disclosure;

FIG. 2 illustrates a process flow diagram of a hybrid Temporal Extraction (TE) module of the system, according to an embodiment of the present disclosure;

FIG. 3 illustrates a process flow diagram of a Temporal Normalization (TN) module of the system, according to an embodiment of the present disclosure; and

FIGS. 4A-4C illustrate flowcharts depicting a method for extracting and normalizing one or more temporal elements from an input text, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure proposes methods and systems for extracting and normalizing one or more temporal elements from an input text. The present disclosure discloses a framework designed to process, extract, and normalize temporal information from the input text. For temporal extraction, the disclosed framework employs a hybrid approach that combines rule-based methods with deep learning techniques to ensure precision. For normalization, the disclosed framework integrates a rule-based method, a holiday resolution approach, and large language models to convert one or more temporal elements into a standardized absolute format. The disclosed versatile temporal processing framework greatly improves the analysis of time-related textual data, offering accurate, standardized, and actionable insights. The disclosed techniques can be applied across a range of industries, including demand forecasting and factory logistics.

It should be noted that the terms “temporal element” and “temporal expression” have been used interchangeably throughout the description and drawings.

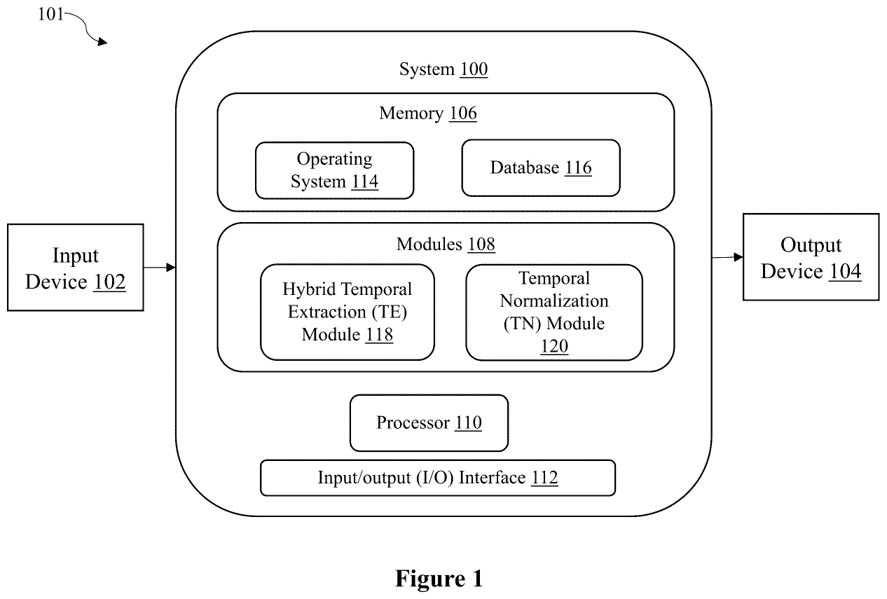

FIG. 1 illustrates an environment 101 including a system 100 for extracting and normalizing one or more temporal elements from an input text, according to an embodiment of the present disclosure.

The environment 101 may include an input device 102 and an output device 104 communicatively coupled to the system 100. The system 100 may be configured to extract and normalize one or more temporal elements from an input text received from the input device 102. The system 100 may be integrated within a server, a personal computing device, a user equipment, a laptop, a tablet, a mobile communication device, and so forth.

In an embodiment, the system 100 may correspond to a stand-alone system provided on an electronic device. The electronic device may include a personal computing device, a user equipment, a laptop, a tablet, a mobile communication device, or any other device capable of hosting processing and memory units. In an embodiment, the input device 102 and/or the output device 104 may be integrated with the electronic device hosting the system 100. In an alternate embodiment, the input device 102 and/or the output device 104 may be separate devices from the electronic device hosting the system 100.

In another embodiment, the system 100 may be based in a server orcloud architecture and the system 100 may be communicably coupled to the input device 102 and the output device 104 via a network (not shown). The network may be a communication network, a wireless network, a wired network, and the like. In another embodiment, the system 100 may be provided in a distributed manner, in that, one or more components of the system 100 may be provided in that, one or more components and/or functionalities of the system 100 are provided through an electronic device, and one or more components and/or functionalities of the system 100 are provided through a cloud-based unit, such as, a cloud storage or a cloud-based server.

In non-limiting examples, the output device 104 may include, but is not limited to, a display unit, an indicating device, a recording device, a computing device, and so forth. In an embodiment, the output device 104 may be associated with a graphical user interface, an interactive user interface, and the like.

The system 100 may include a memory 106, a plurality of modules 108 (herein referred to as the modules 108), at least one processor 110 (herein referred to as the processor 110), and an Input/Output (I/O) interface 112. In an exemplary embodiment, the at least one processor 110 may be operatively coupled to the I/O interface 110, the modules 108, and the memory 106.

In one embodiment, the at least one processor 110 may be operatively coupled to the memory 106 for processing, executing, or performing a set of operations. The at least one processor 110 may include at least one data processor for executing processes in Virtual Storage Area Network. In another embodiment, the at least one processor 110 may include specialized processing units such as, integrated system (bus) controllers, memory management control units, floating point units, graphics processing units, digital signal processing units, etc. In one embodiment, the processor 110 may include a Central Processing Unit (CPU), a Graphics Processing Unit (GPU), or both. In another embodiment, the at least one processor 110 may be one or more general processors, digital signal processors, application-specific integrated circuits, field-programmable gate arrays, servers, networks, digital circuits, analog circuits, combinations thereof, or other now-known or later developed devices for analyzing and processing data. The at least one processor 110 may execute a software program, such as code generated manually (i.e., programmed) to perform one or more operations disclosed in the present disclosure.

The at least one processor 110 may be disposed in communication with one or more I/O devices, such as the input device 102 and the output device 104, via the I/O interface 110. The I/O interface 110 may employ communication Code-Division Multiple Access (CDMA), High-Speed Packet Access (HSPA+), Global System For Mobile Communications (GSM), Long-Term Evolution (LTE), WiMax, or the like, etc.

In an embodiment, the at least one processor 110 may be disposed in communication with a communication network via a network interface. In an embodiment, the network interface may be the I/O interface 110. The network interface may connect to the communication network to enable connection of the system 100 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP)), the Internet, etc. Using the network interface and the communication network, the system 100 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

Furthermore, the memory 106 may include any non-transitory computer-readable medium known in the art including, for example, volatile memory, such as Static Random-Access Memory (SRAM) and Dynamic Random-Access Memory (DRAM), and/or non-volatile memory, such as Read-Only Memory (ROM), erasable programmable ROM, flash memories, hard disks, optical disks, and magnetic tapes.

The memory 106 is communicatively coupled with the processor 110 to store bitstreams or processing instructions for completing the process. Further, the memory 106 may include an operating system 114 for performing one or more tasks of the system 100, as performed by a generic operating system in the communications domain or the standalone device. In an embodiment, the memory 106 may comprise a database 116 configured to store the information as required by the processor 110 to perform one or more functions for estimating the physical properties of the object, as discussed throughout the disclosure.

The memory 106 may be operable to store instructions executable by the processor 110. The functions, acts, or tasks illustrated in the figures or described may be performed by the processor 110 for executing the instructions stored in the memory 106. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

For the sake of brevity, the architecture, and standard operations of the memory 106 and the processor 110 are not discussed in detail. In one embodiment, the memory 106 may be configured to store the information as required by the processor 110 to perform the methods described herein.

The modules 108 amongst other things, include routines, programs, objects, components, data structures, etc., which perform particular tasks or implement data types. The modules 108 may also be implemented as, signal processor(s), state machine(s), logic circuitries, and/or any other device or component that manipulates signals based on operational instructions.

Further, the modules 108 can be implemented in hardware, instructions executed by a processing unit, or by a combination thereof. The processing unit can comprise a computer, a processor, such as the processor 110, a state machine, a logic array, or any other suitable wearable device capable of processing instructions. The processing unit can be a general-purpose processor which executes instructions to cause the general-purpose processor to perform the required tasks or, the processing unit can be dedicated to performing the required functions. In another embodiment of the present disclosure, the modules 108 may be machine-readable instructions (software) which, when executed by a processor/processing unit, perform any of the functionalities described herein.

In some embodiments, the modules 108 may include a set of instructions that may be executed to cause the system 100 to perform any one or more of the methods disclosed herein. The modules 108 may be configured to perform the steps of the present disclosure using the data stored in the memory 106 to facilitate extracting and normalizing the one or more temporal elements from the input text, as discussed throughout this disclosure. In an embodiment, each of the modules 108 may be hardware units that may be outside the memory 106.

In an embodiment, the modules 108 may include a hybrid Temporal Extraction (TE) module 118 and a Temporal Normalization (TN) module 120. The modules 108 and their working are further explained in detail in the following paragraphs.

The various modules 118-120 may be in communication with each other. In an embodiment, the various modules 118-120 may be a part of the processor 110. In another embodiment, the processor 110 may be configured to perform the functions of modules 118-120.

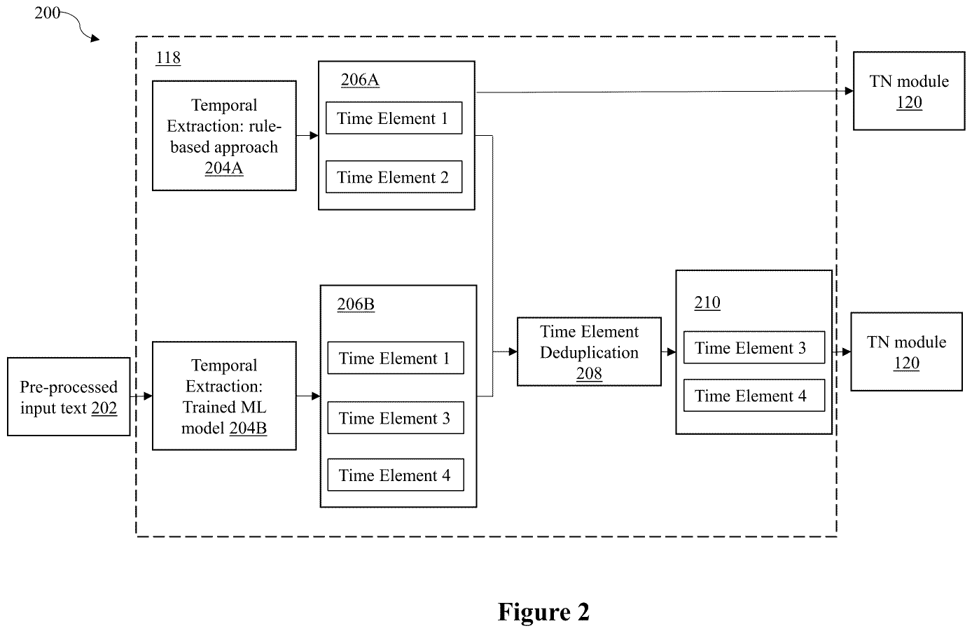

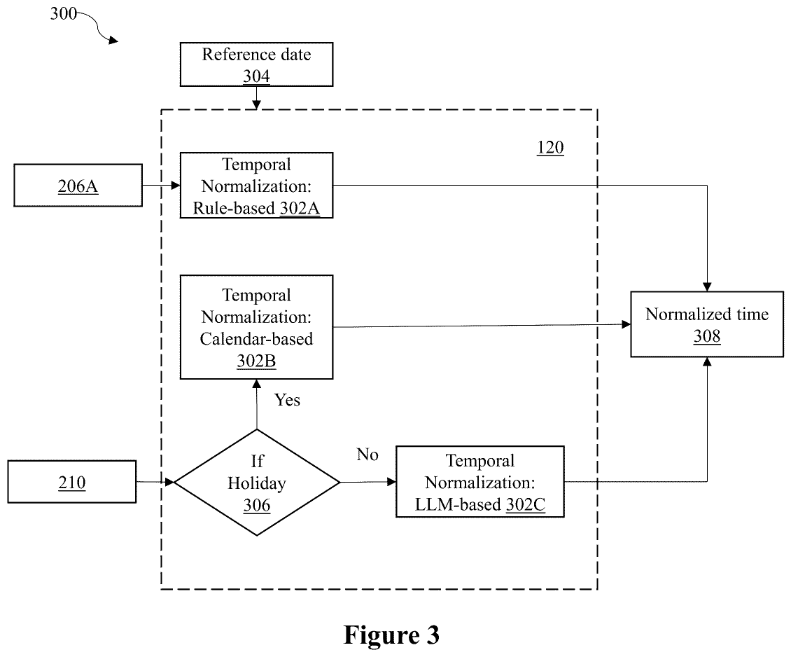

FIG. 2 illustrates a process flow diagram 200 of the hybrid Temporal Extraction (TE) module 118 of the system 100, according to an embodiment of the present disclosure. FIG. 3 illustrates a process flow diagram 300 of the Temporal Normalization (TN) module 120 of the system 100, according to an embodiment of the present disclosure. Referring to FIGS. 1-3 collectively, the input device 102 may receive the input text from a user. In an embodiment, the user may provide the input text to the input device 102 via a User Interface (UI). Further, the input device 102 may send the input text to the system 100. In a non-limiting example, the input device 102 may be a personal computing device, a user equipment, a laptop, a tablet, a mobile communication device, or any other device capable of receiving the input text from the user.

In an embodiment, the system 100 may be configured to receive the input text from the input device 102. The input text may be received by the input device 102 and sent to the at least one processor 110. The system 100 may preprocess the input text through the least one processor 110 based on sentence chunking. The system 100 may identify, using the hybrid TE module 118, temporal expressions, as will be described in detail further below. The temporal expressions may include structured temporal expressions and unstructured temporal expressions. The system 100 may then deduplicate, using the hybrid TE module 118, the temporal expressions detected by a rule-based approach and a trained Machine Learning (ML) model. The system 100 may normalize, using the TN module 120, the deduplicated temporal expressions into a standardized format, based on a hybrid normalization framework, as will be described in detail further below. The system 100 may generate, using the TN module 120, an output comprising the one or more temporal elements highlighted among the input text based on the standardized format, as will be described in detail further below. The output may be displayed on the output device 104.

In an embodiment, the at least one processor 110 may be configured to preprocess the input text received from the input device 102. In an embodiment, the at least one processor 110 may preprocess the input text based on sentence chunking. In an embodiment, the at least one processor 110 may preprocess the input text to prepare for temporal expression extraction to prepare for temporal expression extraction. For example, the at least one processor 110 may divide the input text into at least one of smaller segments or sentences thereby facilitating efficient temporal processing. In an exemplary scenario, let us assume that the user has provided the below input text:
“[T]oday is 30/01/2024 and we plan to travel during Lunar New Year. Our flight is scheduled on tmr, and we will come back on 1st Saturday of Feb.”
Accordingly, the at least one processor 110 may be configured to preprocess the input text and provide the below output to the hybrid TE module 118:
“Today is 30/01/2024;
We plan to travel during Lunar New Year;
Our flight is scheduled on tmr;
we will come back on 1st Saturday of Feb”

The hybrid TE module 118 may then identify temporal expressions from the pre-processed input text (block 202). In an embodiment, the temporal expressions may include but are not limited to structured temporal expressions and unstructured temporal expressions. Further, the temporal expressions may include dates, times, durations, and other time-related entities. The structured temporal expression refers to a precise time reference that is clearly defined with specific date and time components. On the other hand, the unstructured temporal expression refers to time reference that is not clearly defined with specific date and time components. In continuation with the example given in the above paragraph, the structured temporal expression may be “30/01/2024” and the unstructured temporal expression may be “Lunar New Year”. As shown in FIG. 2, the hybrid TE module 118 may identify the temporal expressions using at least one of a rule-based approach (block 204A) and a trained Machine Learning (ML) model (block 204B). In particular, the hybrid TE module 118 may detect the structured temporal expressions, such as time element 1 and time element 2 (block 206A) in the pre-processed input text using at least one of the rule-based approach and the trained ML model. The rule-based approach may utilize one or more rule-based parsing techniques to detect the structured temporal expressions. The one or more rule-based parsing techniques may include but are not limited to regular expression parsing, shift-reduce parsing, recursive descent parsing, semantic parsing, and dependency parsing. The structured temporal expressions in common format such as “DD/MM/YYYY” are very easy to extract by the one or more rule-based parsing techniques via regular expression and by the trained ML model. However, the informal temporal expressions such as commonly used abbreviations (“tmr”, “ytd”, etc) are difficult to be understood by the trained AI model. Accordingly, a list of anchor words is created to capture such temporal information. In an embodiment, the trained ML model may be trained on a dataset comprising at least one of the structured temporal expressions, the unstructured temporal expressions, and the informal temporal expressions. The informal temporal expressions may refer to casual ways to refer to time, such as “the other day” or “a while”. The trained ML model may be trained using techniques known in the art. An example of the structured temporal expressions extracting using the one or more rule-based parsing techniques and the trained ML model is provided in Table 1:

TABLE 1
Rule-based techniques

| | | |
|---|---|---|
| Time element 1 | 30 Jan. 2024 | Regular expression |
| Time element 2 | tmr | Anchor word list |

Trained ML model

| | |
|---|---|
| Time element 1 | 30 Jan. 2024 |

Further, the trained ML model may detect the unstructured temporal expressions in the pre-processed input text. An example of the structured temporal expressions extracting using the one or more rule-based parsing techniques and the trained ML model is provided in Table 2:

TABLE 2

| | |
|---|---|
| Time element 3 | Lunar New Year |
| Time element 4 | 1st Saturday of Feb |

Accordingly, the system 100 handles ambiguous contexts with high precision and high efficiency using the one or more rule-based techniques, meanwhile, the trained ML model learns temporal patterns and adapts to complex and broader range of temporal expressions. In an advantageous aspect, this hybrid approach (i.e., the combination of rule-based techniques and ML model) provides flexible and highly accurate temporal extraction.

Further, as can be noticed from Table 1 and Table 2, the temporal expressions detected by the rule-based approach and the trained ML model may be duplicated. Accordingly, the hybrid TE module 118 may deduplicate (block 208) the temporal expressions detected by the rule-based approach and the trained ML model. In particular, the hybrid TE module 118 may remove duplicates from the temporal expressions to deduplicate the temporal expressions. In an embodiment, the hybrid TE module 118 may compare outputs from the rule-based approach and the trained ML model. Further, the hybrid TE module 118 may compare and retain one or more unique temporal expressions based on the comparison. For example, the rule-based approach provides time elements 1 and 2 as an output (block 206A). Whereas the trained ML model provides time elements 1, 3, and 4 as an output (block 206B). Accordingly, the hybrid TE module 118 may compare these two outputs and retain the unique temporal expressions. For example, as shown in FIG. 2 (block 210), the hybrid TE module 118 has retained the unique temporal expressions of time elements 3 and 4. The unique temporal expressions are then forwarded to the TN module 120 for normalizing the deduplicated temporal expressions, i.e., the unique temporal expressions into a standardized format. The working of the TN module 120 is further explained in FIG. 3.

In an embodiment, the TN module 120 may be configured to normalize the deduplicated temporal expressions into a standardized format. For example, the TN module 120 may be configured to normalize the temporal expression “tmr” to the standardized format of “31/01/2024”. In an embodiment, the TN module 120 may be configured to normalize the deduplicated temporal expressions based on a hybrid normalization framework and a reference date. As shown in FIG. 3, the TN module 120 may receive the reference date 304 as a secondary input for contextual interpretation of the output. In particular, the reference date 304 may be used to normalize the deduplicated temporal expressions into the standardized format. The TN module 120 may receive the reference date 304 prior to normalizing the deduplicated temporal expressions. The reference date 304 may be a sample record time, a comment time, a news publish time, and a similar time. In continuation with the example given in reference to FIGS. 1 and 2, the reference date may be “30/01/2024”. Further, the hybrid normalization framework may comprise a rule-based technique (block 302A) for processing the structured temporal expressions. The rule-based technique (block 302A) may receive the time elements 1 and 2 extracted using the rule-based approach, i.e., from block 206A of FIG. 2. Accordingly, the rule-based technique may normalize the structured temporal expressions, i.e., time elements 1 and 2. The hybrid normalization framework may also comprise a calendar-based technique (block 302B) for normalizing the one or more temporal expressions corresponding to predetermined event dates. In particular, the TN module 120 may receive (block 306) the unique temporal expressions, i.e., time elements 3 and 4 from block 210 of FIG. 2. Accordingly, the TN module 120 may then determine (block 306) if the received temporal expressions correspond to the predetermined event dates. If yes, then the TN module 120 may use the calendar-based technique to normalize the one or more temporal expressions. The predetermined event dates may include but are not limited to holiday dates, and special events, such as Covid, lockdown. For example, the calendar-based technique may normalize the temporal expression time element 3, i.e., “Lunar New Year”. Accordingly, the calendar-based technique may normalize the temporal expressions related to the specific calendar or cultural context. However, if the TN module 120 determines (block 306) that the temporal expressions do not correspond to the predetermined event dates, then the TN module 120 may use a Large Language Model (LLM)-based technique (block 302C) for normalizing the one or more temporal expressions. Accordingly, the hybrid normalization framework may comprise the LLM-based technique for normalizing the one or more temporal expressions not corresponding to the predetermined event dates. The LLM may be trained on large amounts data and interpret temporal expressions based on context with high flexibility and adaptability, such as famous events and complex time/date descriptions. As shown, the hybrid normalization framework, i.e., normalizes the one or more temporal expressions and provides the normalized one or more temporal expressions to a normalized time block (block 308). The normalized time block 308 may collect the normalized one or more temporal expressions from each of the hybrid normalization techniques and provide the normalized one or more temporal expressions to the processor 110. An example of the normalized one or more temporal expressions is shown below in Table 3:

TABLE 3

| | | |
|---|---|---|
| | | Process for |
| Extracted Time | Normalized Time | normalization |

Rule-based

| | | |
|---|---|---|
| 30 Jan. 2024 | 30 Jan. 2024 | |
| tmr | 30 Jan. 2024 | Reference date + 1 day |

Calendar-based

| | | |
|---|---|---|
| Lunar New Year | 2 Feb. 2024 | Lookup Lunar New |
| | | Year for the given year |

LLM-based

| | | |
|---|---|---|
| 1st Saturday of Feb | 10 Feb. 2024 | Using inference |

Accordingly, the disclosed hybrid method combining both techniques provides the necessary specificity and accuracy in temporal normalization.

The TN module 120 may generate an output comprising the one or more temporal elements highlighted among the input text based on the standardized format. In an embodiment, the generated output may include the input text with the highlighted one or more temporal elements and a list of the extracted and normalized one or more temporal expressions. In an embodiment, the TN module 120 may provide the generated output to the output device 104. The generated output may be in a machine-readable format. An example of the output is shown in Table 4:

TABLE 4

| | | Normalized |
|---|---|---|
| | Extracted Time | Time |
| Today is 30 Jan. 2024. We plan | 30 Jan. 2024 | 30 Jan. 2024 |
| to travel during Lunar New Year. | tmr | 30 Jan. 2024 |
| Our flight is scheduled on tmr, | Lunar New Year | 2 Feb. 2024 |
| and we will come back on 1st | 1st Saturday of Feb | 10 Feb. 2024 |
| Saturday of Feb. | | |

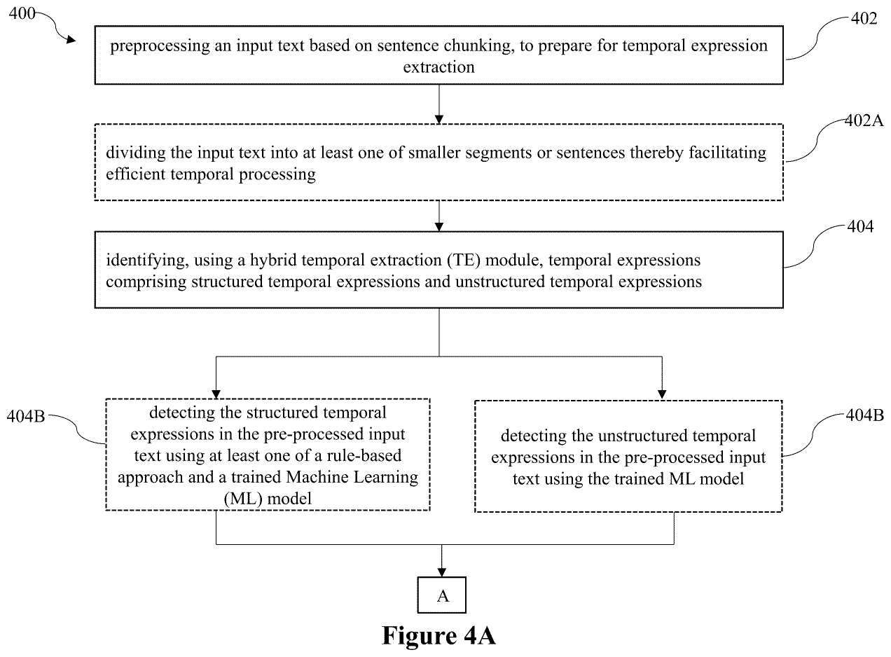

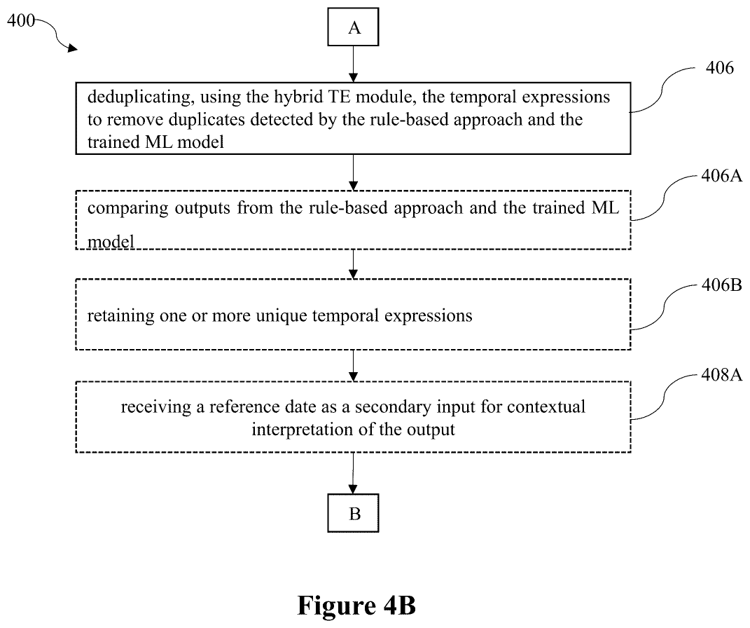

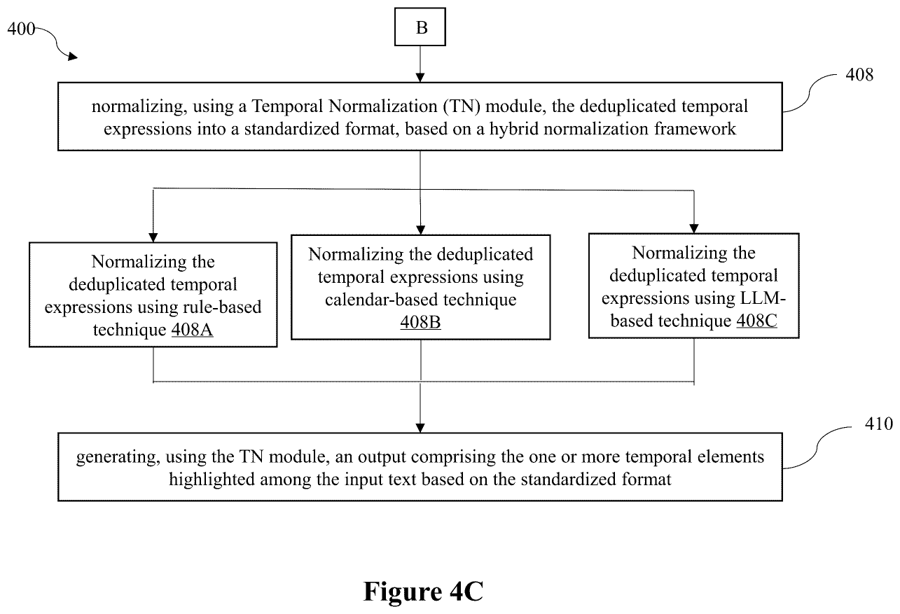

FIGS. 4A-4C illustrate flowcharts depicting a method 400 for extracting and normalizing one or more temporal elements from the input text, according to another embodiment of the present disclosure. The method 400 may be performed by the system 100, in particular, the processor 110 of the system 100.

The method 400 may include receiving the input text from the input device 102.

At step 402, the method 400 may include preprocessing the input text based on sentence chunking. In an embodiment, as shown at step 402A, the method 400 may include dividing the input text into at least one of smaller segments or sentences thereby facilitating efficient temporal processing, to preprocess the input text.

At step 404, the method 400 may include identifying the temporal expressions comprising structured temporal expressions and unstructured temporal expressions, from the pre-processed input text. The process of identifying the temporal expressions is further explained at steps 404A and 404B. As shown, at step 404A, the method 400 may include detecting the structured temporal expressions in the pre-processed input text using at least one of the rule-based approach and the trained ML model. Further, at step 404B, the method 400 may include detecting the unstructured temporal expressions in the pre-processed input text using the trained ML model. It should be noted that the step 404 may be performed using at least one of the processes described at steps 404A and 404B.

At step 406, the method 400 may include deduplicating the temporal expressions detected by the rule-based approach and the trained ML model. In an embodiment, as shown at step 406A, the method 400 may include deduplicating the temporal expressions by comparing outputs from the rule-based approach and the trained ML model. Then, at step 406B, the method 400 may include retaining the one or more unique temporal expressions.

Then, at step 408, the method 400 may include normalizing the deduplicated temporal expressions into the standardized format, based on the hybrid normalization framework and the reference date. The process of normalizing the deduplicated temporal expressions is further explained at steps 408A-408C. As shown, at step 408A, the method 400 may include normalizing the deduplicated temporal expressions using the rule-based technique. The method 400 may use the rule-based technique when the deduplicated temporal expressions are extracted using the rule-based approach. Further, at step 408B, the method 400 may include normalizing the deduplicated temporal expressions using the calendar-based technique. The method 400 may use the calendar-based technique when the deduplicated temporal expressions are extracted using the trained ML model and correspond to the predetermined event dates. At step 408C, the method 400 may include normalizing the deduplicated temporal expressions using the LLM-based technique. The method 400 may use the LLM-based technique when the deduplicated temporal expressions are extracted using the trained ML model and do not correspond to the predetermined event dates.

In an exemplary embodiment, prior to normalizing the deduplicated temporal expressions, at step 408, the method 400 may include receiving the reference date as the secondary input for contextual interpretation of the output.

Then, at step 410, the method 400 may include generating the output comprising the one or more temporal elements highlighted among the input text based on the standardized format.

While the above-discussed steps in FIGS. 4A-4C are shown and described in a particular sequence, the steps may occur in variations to the sequence in accordance with various embodiments. Further, a detailed description related to the various steps of FIGS. 4A-4C is already covered in the description related to FIGS. 1-3 and is omitted herein for the sake of brevity.

Accordingly, the present disclosure provides the following advantages:
The disclosed techniques enable the extraction of temporal information from ambiguous, context-dependent, or complex temporal expressions.
The disclosed techniques accurately process and standardize temporal data in a wide range of natural language contexts.
The disclosed techniques handle ambiguous contexts with high precision and high efficiency.
The disclosed hybrid approach (i.e., the combination of rule-based techniques and ML model) provides flexible and highly accurate temporal extraction.
The present disclosure provides techniques for specific and accurate temporal normalization.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for extracting and normalizing one or more temporal elements from an input text, the method comprising:
preprocessing an input text based on sentence chunking;
identifying, using a hybrid Temporal Extraction (TE) module, temporal expressions comprising structured temporal expressions and unstructured temporal expressions, from the pre-processed input text;
deduplicating, using the hybrid TE module, the temporal expressions detected by the rule-based approach and the trained ML model;
normalizing, using a Temporal Normalization (TN) module, the deduplicated temporal expressions into a standardized format, based on a hybrid normalization framework and a reference date; and
generating, using the TN module, an output comprising the one or more temporal elements highlighted among the input text based on the standardized format.

2. The method of claim 1, wherein identifying the temporal expressions comprises:
identifying the temporal expressions based on at least one of:
detecting the structured temporal expressions in the pre-processed input text using at least one of a rule-based approach and a trained Machine Learning (ML) model, and
detecting the unstructured temporal expressions in the pre-processed input text using the trained ML model.

3. The method of claim 1, wherein prior to normalization of the deduplicated temporal expressions, the method comprises:
receiving the reference date as a secondary input for contextual interpretation of the output.

4. The method of claim 1, wherein the preprocessing comprises:
dividing the input text into at least one of smaller segments or sentences thereby facilitating efficient temporal processing.

5. The method of claim 1, wherein the rule-based approach utilizes one or more rule-based parsing techniques to detect the structured temporal expressions.

6. The method of claim 1, wherein the trained ML model is trained on a dataset comprising at least one of the structured temporal expressions, the unstructured temporal expressions, and informal temporal expressions.

7. The method of claim 1, wherein the deduplication step comprises:
comparing outputs from the rule-based approach and the trained ML model; and
retaining one or more unique temporal expressions.

8. The method of claim 1, wherein the hybrid normalization framework comprises a rule-based technique for processing the structured temporal expressions.

9. The method of claim 1, wherein the hybrid normalization framework comprises a calendar-based technique for normalizing the one or more temporal expressions corresponding to predetermined event dates.

10. The method of claim 1, wherein the hybrid normalization framework comprises a Large Language Model (LLM)-based technique for normalizing the one or more temporal expressions not corresponding to predetermined event dates.

11. The method of claim 1, wherein the generated output comprises:
the input text with the highlighted one or more temporal elements and a list of the extracted and normalized one or more temporal expressions in a machine-readable format.

12. A system for extracting and normalizing one or more temporal elements from an input text, the system comprising:
a memory;
at least one processor in communication with the memory, the at least one processor configured to:
preprocess an input text based on sentence chunking;
identify, using a hybrid temporal extraction (TE) module, temporal expressions comprising structured temporal expressions and unstructured temporal expressions, from the pre-processed input text;
deduplicate, using the hybrid TE module, the temporal expressions detected by the rule-based approach and the trained ML model;
normalize, using a temporal normalization (TN) module, the deduplicated temporal expressions into a standardized format, based on a hybrid normalization framework and a reference date; and
generate, using the TN module, an output comprising the one or more temporal elements highlighted among the input text based on the standardized format.

13. The system of claim 12, wherein the at least one processor is configured to identify the temporal expressions based on at least one of:
detecting the structured temporal expressions in the pre-processed input text using at least one of a rule-based approach and a trained Machine Learning (ML) model, and detecting the unstructured temporal expressions in the pre-processed input text using the trained ML model.

14. The system of claim 12, wherein prior to normalization of the deduplicated temporal expressions, the at least one processor is configured to:
receive the reference date as a secondary input for contextual interpretation of the output.

15. The system of claim 12, wherein for preprocessing, the at least one processor is configured to:
divide the input text into at least one of smaller segments or sentences thereby facilitating efficient temporal processing.

16. The system of claim 12, wherein the rule-based approach utilizes one or more rule-based parsing techniques to detect the structured temporal expressions.

17. The system of claim 12, wherein the trained ML model is trained on a dataset comprising at least one of the structured temporal expressions, the unstructured temporal expressions, and informal temporal expressions.

18. The system of claim 12, wherein for deduplication, the at least one processor is configured to:
compare outputs from the rule-based approach and the trained ML model; and
retain one or more unique temporal expressions.

19. The system of claim 12, wherein the hybrid normalization framework comprises a rule-based technique for processing the structured temporal expressions.

20. The system of claim 12, wherein the hybrid normalization framework comprises a calendar-based technique for normalizing the one or more temporal expressions corresponding to predetermined event dates.

21. The system of claim 12, wherein the hybrid normalization framework comprises a Large Language Model (LLM)-based technique for normalizing the one or more temporal expressions not corresponding to predetermined event dates.

22. The system of claim 12, wherein the generated output comprises:
the input text with the highlighted one or more temporal elements and a list of the extracted and normalized one or more temporal expressions in a machine-readable format.
